(19) United States
(12) Patent Application Publication
(10) Pub. No.: US 2007/0243264 A1
(43) Pub. Date: Oct. 18, 2007

(54) Thickened Dilute Hypochlorite

(76) Inventors: Aram Garabedian, Fremont, CA (US); Lachelle Arnt, Pleasanton, CA (US); William L. Smith, Pleasanton, CA (US)

Correspondence Address: THE CLOROX COMPANY, P.O. BOX 24305, OAKLAND, CA, 94623-1305, US

(21) Appl. No.: 11/379,135

(22) Filed: Apr. 18, 2006

(51) Int. Cl. A01N 59/08

(52) U.S. Cl. 424/661

(57) ABSTRACT

This invention relates to methods of thickening dilute hypochlorite and hypochlorous acid compositions. These compositions are thickened with inorganic thickeners, especially synthetic clays. The compositions can additionally contain buffering agents. The compositions show good performance on mold.

### BACKGROUND OF THE INVENTION

1. Field of the Invention

This invention relates to compositions and methods of use for thickened, dilute hypohalous acid, hypohalous acid salt, and compositions containing these actives. The resulting compositions are useful for controlling mold, especially on vertical surfaces. The resulting compositions can be applied by a variety of means, including spraying, applying as a bead, and as part of a patch. The resulting compositions can be applied on hard surfaces or soft surfaces.

2. Description of the Related Art

U.S. Pat. No. 6,333,054 to Rogozinski describes electrolytically generated hypochlorite solutions thickened with Laponite clay. PCT App. WO97/11147 to Liciani describes hypochlorite thickened with a combination of clay and acrylic polymer. U.S. Pat. App. 2006/0011885 describes a thickened hypochlorite abrasive cleaner, where clay is one of the disclosed thickeners. Prior art references have not recognized that thickened, dilute hypochlorite compositions can be effective at treating mold.

Based on the prior art examples, various novel formulations and methods have been discovered for hypohalous acid, hypohalous acid salt, and compositions containing these actives.

### SUMMARY OF THE INVENTION

In accordance with the above objects and those that will be mentioned and will become apparent below, one aspect of the present invention is a composition comprising:
a. 50 ppm to 1000 ppm hypohalous acid and hypohalous acid salt as available chlorine;
b. 0.1% to 10% by weight synthetic silicate clay;
c. wherein the composition comprises less than 0.1% by weight surfactant;
d. wherein the composition has a pH of less than pH 11; and
e. wherein the hypohalous acid and hypohalous acid salt is formed from the neutralization of chlorine gas with caustic solution.

In accordance with the above objects and those that will be mentioned and will become apparent below, another aspect of the present invention is method of treating mold comprising:
a. applying a composition comprising 50 ppm to 1000 ppm hypohalous acid and hypohalous acid salt as available chlorine and 0.1% to 5% by weight synthetic silicate clay;
b. wherein the composition has a pH of less than 11.

In accordance with the above objects and those that will be mentioned and will become apparent below, another aspect of the present invention is method of treating mold comprising:
a. applying a composition comprising 50 ppm to 1000 ppm hypohalous acid and hypohalous acid salt as available chlorine and 0.1% to 5% by weight inorganic thickener;
b. wherein the composition has a pH of less than 11.

Further features and advantages of the present invention will become apparent to those of ordinary skill in the art in view of the detailed description of preferred embodiments below.

### DETAILED DESCRIPTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (“%'s”) are in weight percent (based on 100% active) of the cleaning composition alone.

The term “surfactant”, as used herein, is meant to mean and include a substance or compound that reduces surface tension when dissolved in water or water solutions, or that reduces interfacial tension between two liquids, or between a liquid and a solid. The term “surfactant” thus includes anionic, nonionic, cationic and/or amphoteric agents.

As used herein, the term “microbiological contaminants” refers to any microbial contaminant. Example of microbiological contaminants include, but are not limited to, fungi, bacteria, viruses, protista, and molds, including mold spores. Examples of such microbiological contaminants include Stachybotrys Chartarum, Aspergillus niger, Absidia sp., Acrodorticm salmoneum, Aspergillus candies, anthrax, etc.

The term “surface” refers to hard and soft surfaces and includes, but are not limited to, tile grout, plaster, drywall, ceramic, cement, clay, bricks, stucco, plastic, wallpaper, fabric, tiles, cement, and vinyl flooring, heating and/or cooling fins, filters, vanes, baffles, vents, crevices in walls or ceilings, paper and wood products such as lumber, paper, and cardboard, woven products such as blankets, clothing, carpets, drapery and the like.

Hypohalous Acid and Salts

Suitable hypohalous acids and salts may be provided by a variety of sources, including compositions that lead to the formation of positive halide ions and/or hypohalite ions; hypohalous acid, hypohalous acid salt, hypohalous acid generating species, hypohalous acid salt generating species; as well as compositions that are organic based sources of halides, such as chloroisocyanurates, haloamines, haloimines, haloimides and haloamides, or mixtures thereof. These compositions may also produce hypohalous acid or hypohalite species in situ. Suitable hypohalous acids and salts for use herein include the alkali metal and alkaline earth metal hypochlorites, hypobromites, hypoiodites, chlorinated trisodium phosphate dodecahydrates, potassium and sodium dichloroisocyanurates, potassium and sodium trichlorocyanurates, N-chloroimides, N-chloroamides, N-chlorosulfamide, N-chloroamines, chlorohydantoins such as dichlorodimethyl hydantoin and chlorobromo dimethylhydantoin, bromo-compounds corresponding to the chloro-compounds above, and compositions which generate the corresponding hypohalous acids, or mixtures thereof.

In one embodiment wherein the compositions herein are liquid, said hypohalite composition comprises an alkali metal and/or alkaline earth metal hypochlorite, or mixtures thereof. Compositions may comprise an alkali metal and/or alkaline earth metal hypochlorite selected from the group consisting of sodium hypochlorite, potassium hypochlorite, magnesium hypochlorite, lithium hypochlorite and calcium hypochlorite, and mixtures thereof.

The hypohalous acids and salt composition may be an equilibrium mixture of hypochlorous acid and hypochlorite salt, for example, sodium hypochlorite. The active species is present in an amount from above zero to about 15 weight percent of the composition, or from about 0.001 weight percent (10 ppm) to about 10 weight percent of the composition, or from about 0.005 (50 ppm) to about 5 weight percent of the composition. Dilute solutions of hypohalous acid and salt are generally below 1000 ppm.

The amount of available halogen oxidant in the composition is determined by placing samples of the composition into about 50 milliliters of distilled water, followed by addition of about 10 milliliters of a 10 weight/weight percent solution of potassium iodide and addition of about 10 milliliters of a 10 volume percent solution of sulfuric acid, the resulting mixture being well stirred. The resulting yellow to brown solution, whose color is the result of oxidation of free iodine ion (I⁻) to molecular iodine (I₂), was then volumetrically titrated to an essentially colorless endpoint by addition of standardized 0.1 Molar sodium thiosulfate (Na₂S₂O₃) titrant. Calculation then expresses the result as percent of available molecular chlorine (Cl₂), that is to say assigning two equivalents per mole of titrated hypohalite oxidant. Stability results are then expressed by repeated assays over time using identically prepared samples resulting from the same composition, normalized to 100 percent representative of the starting available chlorine measured initially.

Although hypohalous acid and hypohalous acid salt compositions can be useful over the entire pH range of 2 to 13, some benefits, such as the mold control, may require pH less than about pH 10, or less than pH 9, or less than pH 8, or less than pH 7. The compositions can include buffer systems, such as carboxylic acids and their salts, for example acetic acid or succinic acid. Other useful buffer systems would include borates, bicarbonates, hydrogen phosphates, and mixed metal silicates.

The hypohalous acid and hypohalous acid salt can be formed from the neutralization of chlorine gas with caustic solution, during which an equimolar amount of halide is also formed. In electrolysis, halide is consumed and none is formed. Dilute hypohalous acid and salt technology is described in U.S. Pat. App. 2005/0214,386, U.S. Pat. App. 2005/0216,291, U.S. Pat. App. 2005/0232,847, U.S. Pat. App. 2005/0232,848, U.S. Pat. App. 2005/0221,113, U.S. Pat. App. 2005/0233,900 and U.S. Pat. App Ser. No. 11/277,642 entitled “Antimicrobial Product Combination”, all of which are incorporated by reference herein.

Thickener

The inorganic thickener can be any natural or synthetic clays, aluminas, etc. One suitable class of thickeners include colloid-forming clays, for example, such as smectite and/or attapulgite types. The smecties are a family of water swellable clays having a lattice sheet structure. Smectite clays are more commonly known as bentonite or magnesium aluminium silicate. Once hydrated, most smectites form an alkaline dispersion. Water washed smectite clays are often preferred because they are controlled for purity, bacteria, whiteness, heavy metals and performance efficiency. The smectites produce thixotropic, pseudoplastic dispersions with yield value. These clays are available in a range of viscosities, although their primary functions is to impart yield value and thereby stabilize emulsions, suspension, and foams. They are often used in combination with anionic and nonionic organic thickeners to finely tailor rheology and for advantages synergism in viscosity and/or yield value. The hormites are water dispersible clays with a chain structure that results in microscopic, needle-like particles. The commercial varieties are palygorskite, more commonly known as attapulgite, and sepiolite. The primary commercial palygorskite, attapulgite has typically short (less than 2 um) and low aspect ratio (less than 10:1) needles. When hormite clays are dispersed in water, they do not swell like smectites, but deagglomerate in proportion to the amount of shear applied, and form a random colloidal network. This loosely cohesive structure offers rheological properties similar to those of smectite clays but often with somewhat less physical stability.

Laponite® clay shear thins. The shear thinning behavior is suitable for dispensing through a spray applicator that may be trigger or pump activated or an aerosol. It then rethickens on the surface.

The clay materials can be described as expandable layered clays, i.e., aluminosilicates and magnesium silicates. The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites). Smectites are three-layered clays. There are two distinct classes of smectite-type clays. In the first, aluminum oxide is present in the silicate crystal lattice; in the second class of smectites, magnesium oxide is present in the silicate crystal lattice. The general formulas of these smectites are Al₂(Si₂O₅)₂(OH)₂ and Mg₃(Si₂O₅)(OH)₂, for the aluminum and magnesium oxide type clays, respectively. It is to be recognized that the range of the water of hydration in the above formulas may vary with the processing to which the clay has been subjected.

Commercially available clays include, for example, montmorillonite (bentonite), volchonskoite, nontronite, beidellite, hectorite, saponite, sauconite and vermiculite. The clays herein are available under various trade names such as Gelwhite H NF® and Gelwhite GP® from Southern Clay Products. (both montmorillonites); Van Gel O® from R. T. Vanderbilt, smectites, laponites and layered silicates from Southern Clay Products. A second type of expandable clay material useful in the instant invention is classified geologically as attapulgite (polygorskite). Attapulgites are magnesium-rich clays having principles of superposition of tetrahedral and octahedral unit cell elements different from the smectites. Like the smectites, attapulgite clays are commercially available. For example, such clays are marketed under the tradename Attagel®, i.e. Attagel 40®, Attagel 50® and Attagel 150® from Engelhard Minerals & Chemicals Corporation.

One such synthetic mineral is sodium lithium magnesium silicate (CAS Reg. No. 53320-86-8) and in the Cosmetic, Toiletries and Fragrance Association (CTFA) dictionary as Sodium Magnesium Silicate. This synthetic mineral is sold commercially under the trade name Laponite®, a registered trademark of Southern Clay Products, Inc., Gonzales, Tex.

The thickener may form a viscous solution, a flowable gel or a rigid gel. The thickener component may be used in amounts of about 0.1% to 10% by weight.

Optional Ingredients

The compositions may also include minor amounts, generally not more than at total of 1% wt., desirably less than 0.1% wt. of one or more optional constituents including ones which may improve the aesthetic appeal of the compositions, viz., perfumes and colorants. These optional ingredients may be present in larger amounts if they are kept physically separated from the hypohalous acid composition during long-term storage. Such optional constituents should not undesirably affect the shelf stability or rheology of the compositions. By way of non-limiting example such further constituents include one or more coloring agents, fragrances and fragrance solubilizers, viscosity modifying agents, other surfactants, pH adjusting agents and pH buffers including organic and inorganic salts, optical brighteners, opacifying agents, hydrotropes, antifoaming agents, anti-spotting agents, preservatives, and anti-corrosion agents. The use and selection of these optional constituents is well known to those of ordinary skill in the art.

Where the composition is used to treat mold or other microbiological contaminants, the addition of other agents that have short-term or long-term effectiveness against these contaminants may be included. For example, octaborate is known to be effective against the reoccurrence of mold and mildew.

Delivery

The compositions of the invention can be delivered via bottle, spray, aerosol, or a directed flow such as the bleach pen as in U.S. Pat. No. 6,905,276. The compositions of the invention can be delivery via devices described in U.S. Pat. App. 2005/0221113 and U.S. Pat. App. 2005/0232848. The compositions of the invention can be delivered as part of a multi-compartment delivery system, for example as described in U.S. Pat. No. 5,954,213, U.S. Pat. No. 5,316,159, WO2004/014760, U.S. Pat. No. 6,610,254, and U.S. Pat. No. 6,550,694.

Efficacy

Dilute sprayable hypochlorite bleach formulations (less than about 0.5% sodium hypochlorite) with a neutral pH are effective sanitizing and disinfecting agents. However, because these formulations do not possess cling properties they tend to runoff vertical surfaces or drip from overhead surfaces like ceilings. This reduces the amount of actives in contact with those surfaces and makes their application somewhat limited. Stain removal efficacy (especially mildew stain removal) of neutral, dilute sprayable hypochlorite bleach formulations (less than about 0.5% sodium hypochlorite) is improved by the addition of small amounts of inorganic thickener such as clay. The inorganic thickener imparts thixotropic properties to the bleach formulation, such that it overcomes the limitations inherent to non-thickened solutions. Because of the increased contact time, the dilute compositions are effective, and the compositions may avoid some of the negatives, such as odor, associated with higher concentrations of actives.

### EXAMPLES

Four drops of a solution of 200 ppm hypochlorite at pH 7 thickened with various amounts of Laponite® were placed on a Bisque Tile with Aspergillus niger and the residence time for the drop measured with the tile in a horizontal orientation. The results are given in Table 1. Solutions of approximately 200 ppm hypochlorite and different pH values were tested for stability and effectiveness at decolorizing Aspergillus niger on a Bisque Tile (10 is completely decolored, 1 is not decolored) and the results are given in Table 2.

TABLE 1

| | Residence time on |
|---|---|
| % Laponite ® | horizontal tile (min) |
| 0 | 0.5 |
| 0.25 | 2 |
| 0.5 | 3 |
| 0.75 | 4.5 |
| 1 | 6 |

TABLE 2

| | Stability vs. | Thickened | Unthickened |
|---|---|---|---|
| | Unthickened at 11 | Decolorization of | Decolorization of |
| pH | days and 120° F. | Aspergillus niger | Aspergillus niger |
| 5 | 79% | 7 | 3 |
| 7 | 94% | 7 | 3 |
| 9 | 98% | 8 | 2 |
| 11 | 100% | 3 | 1 |

Solutions of 200 ppm hypochlorite were thickened with Laponite® with added buffers to give viscous liquids or gels, as shown in Table 3. Gels were also formed with the addition of acetic acid or hydrochloric acid.

TABLE 3

| Buffer | Wt. % | pH | gel |
|---|---|---|---|
| Boric acid | 0.21 | 8.5 | Yes |
| Boric acid | 0.41 | 8.4 | Yes |
| Succinic acid | 0.01 | 9.2 | Yes |
| Succinic acid | 0.04 | 8.2 | Viscous liquid |

Various thickeners were tested at 1% concentration and pH 7 for their effect on the stability of dilute hypochlorite and results are shown in Table 4. By comparison, surfactants that are normally considered stable to hypochlorite, such as sodium alkylbenzenesulfonate, trimethylC₁₆ ammonium chloride, sodium lauryl sulfate, and sodium octyl sulfonate, were less stable than Vangel ES®. At higher pH values, the thickener will likely have higher stability.

TABLE 4

| | | % NaOCl remaining |
|---|---|---|
| Thickener | Type | after 8 days at 120° F. |
| None | | 84.8% |
| Laponite R ® | Synthetic silicate | 84.5 |
| | hectorite clay | |
| Vangel ES ® | Mg aluminum silicate | 63.0 |
| | smectite clay | |
| Vangel B ® | Mg aluminum silicate | 0 |
| | smectite clay | |
| Catapal D ® | alumina | 0 |

Laponite® was also observed to improve the wetting behavior of dilute hypochlorite compositions. When a solution of 200 ppm hypochlorite at pH 7 thickened with 0.5% or 1% by weight. Laponite® was sprayed onto a mirror and then wiped, it was found to dry evenly, whereas the solution without Laponite® was found to dry with droplets and fisheyes. Additionally, the mirror treated with the Laponite® containing hypochlorite solution left a surface that easily rewet, so that water spread evenly on the surface. The solution without Laponite® did not leave a surface that easily rewet, to that water runs off unevenly from the surface.

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

We claim:

1. A composition comprising:
a. 50 ppm to 1000 ppm hypohalous acid and hypohalous acid salt as available chlorine;
b. 0.1% to 10% by weight synthetic silicate clay;
c. wherein the composition comprises less than 0.1% by weight surfactant;
d. wherein the composition has a pH of less than pH 11; and
e. wherein the hypohalous acid and hypohalous acid salt is formed from the neutralization of chlorine gas with caustic solution.

2. The composition of claim 1, wherein the composition additionally comprises a buffer.

3. The composition of claim 2, wherein the buffer is the salt of an organic acid.

4. The composition of claim 3, wherein the buffer is succinate.

5. The composition of claim 3, wherein the buffer is acetate.

6. The composition of claim 2, wherein the buffer is the salt of a multivalent inorganic acid or multivalent inorganic acid salt.

7. The composition of claim 6, wherein the buffer is boric acid or borate.

8. The composition of claim 1, wherein the clay is laponite.

9. The composition of claim 1, wherein the composition comprises 50 ppm to 500 ppm hypohalous acid and hypohalous acid salt as available chlorine.

10. The composition of claim 1, wherein the pH is less than 9.

11. A method of treating mold comprising:
a. applying a composition comprising 50 ppm to 1000 ppm hypohalous acid and hypohalous acid salt as available chlorine and 0.1% to 5% by weight synthetic silicate clay;
b. wherein the composition has a pH of less than 11.

12. The method of claim 11, wherein the composition is applied to a vertical hard surface.

13. The method of claim 11, wherein the composition comprises less than 0.1% by weight surfactant.

14. The method of claim 11, wherein the composition additionally comprises a buffer.

15. The method of claim 14, wherein the buffer is the salt of an organic acid.

16. The method of claim 14, wherein the buffer is the salt of a multivalent inorganic acid or multivalent inorganic acid salt.

17. The method of claim 16, wherein the buffer is boric acid or borate.

18. The method of claim 11, wherein the clay is laponite.

19. The method of claim 11, wherein the composition comprises 50 ppm to 500 ppm hypohalous acid and hypohalous acid salt as available chlorine.

20. The method of claim 11, wherein the pH is less than 9.

21. A method of treating mold comprising:
a. applying a composition comprising 50 ppm to 1000 ppm hypohalous acid and hypohalous acid salt as available chlorine and 0.1% to 5% by weight inorganic thickener;
b. wherein the composition has a pH of less than 11.
